(19) United States
(12) Patent Application Publication
(10) Pub. No.: US 2012/0233633 A1
(43) Pub. Date: Sep. 13, 2012

(54) USING IMAGE OF VIDEO VIEWER TO ESTABLISH EMOTION RANK OF VIEWED VIDEO

(75) Inventor: Yuko Nishikawa, La Jolla, CA (US)

(73) Assignee: SONY CORPORATION

(21) Appl. No.: 13/043,831

(22) Filed: Mar. 9, 2011

(51) Int. Cl. H04H 60/33

(52) U.S. Cl. 725/12

(57) ABSTRACT

A method whereby an actual image of a TV viewer as captured by a camera housed in the TV or an emotion rank, which is either an emoticon or descriptive words corresponding to the emoticon, generated by ranking engine software can be displayed on the viewer's display or uploaded to a social networking website on the Internet. The viewer may also vote in categorical manner on multiple images of friend's faces pertaining to the video currently being presented.

### I. FIELD OF THE INVENTION

The present invention relates generally to using images of viewers to establish an emotion ranking for a video being viewed by the imaged viewers.

### II. BACKGROUND OF THE INVENTION

Television displays have been a source of entertainment for friends and families for decades, but the viewers must be together in the same room to share laughter, words, or facial emotions without the use of supplemental equipment such as phones or cameras. Some computers have implemented cameras into the housing or chassis that the user's image can be captured on and streamed over the Internet and viewed by a friend or family member, but this is not a common feature on TVs. As understood herein, it would be desirable to enable friends or family members who are not viewing the same TV to share facial expressions with one another via a network such as the Internet.

### SUMMARY OF THE INVENTION

As understood herein, facial recognition software is able to detect emotion of a person based on an image taken of them. Present principles recognize that the emotion information can be converted into animated images, or “emoticons,” or descriptive words that correspond to the detected emotion to, e.g., allow a TV viewer's image to be converted into an emoticon and sent to a friend's TV display.

Accordingly, a system includes a viewer video display and a processor coupled to the viewer video display. The processor can also communicate with a camera and can execute logic on a computer readable storage medium to generate an image of the viewer using the camera and to upload the image to a ranking mechanism. The processor can receive back from the ranking engine the original image of the viewer and an emotion rank pertaining to a video presented on the display and can overlay the image of the viewer and/or emotion rank onto the video. The emotion rank can be an emoticon emulating the viewer's face or descriptive words that correspond to the detected emotion.

The processor can present a user interface (UI) on the display, thereby enabling a viewer to select items, i.e. image of viewer or emotion rank, that can be used for further action. The processor's presentation of a UI can enable a viewer to also select to have an image of his or her face and/or emotion rank uploaded to a viewer-defined social networking site on the Internet. The presentation of the UI can thirdly enable a viewer to select to have the emotion rank received from the ranking engine or the original image of the viewer's face presented on the display.

The UI presented by the processor on the display can enable a viewer to vote on images of viewer faces downloaded from the ranking engine and presented on the display. The images of viewer faces may pertain to the video presented on the display. The UI can enable a viewer to vote on a “best” face at least in part by clicking on one of the images of viewer faces downloaded from the ranking engine and presented on the display. The UI further can enable a viewer to vote on a face based on the face presenting a particular emotion listed on the UI.

In another aspect, a method includes generating an image of a viewer of a TV using a camera associated with the TV, providing the image to a ranking mechanism, and receiving back from the ranking engine the image and an emotion rank pertaining to a video presented on the display. The method also includes overlaying the original image and/or emotion rank onto the video. The emotion rank is an emoticon emulating the viewer's face and/or descriptive words that correspond to the detected emotion.

In another aspect, an apparatus has a viewer video display, a processor coupled to the viewer video display, and a camera communicating with the processor. The processor executes logic on a computer readable storage medium to, responsive to a viewer selection to capture a picture of his or her face, causing an image of the viewer to be captured. The processor also provides the image to a ranking engine and receives from the ranking engine an emotion rank. The processor, responsive to user command, overlays the image and/or the emotion rank onto a video being played on the display to enable a viewer to watch the video being played and view the image and/or emotion rank simultaneously.

Example implementation details of present principles are set forth in the description below, in which like numerals refer to like parts, and in which:

### BRIEF DESCRIPTION OF THE DRAWINGS

FIG. 1 is a block diagram of an example video display system implemented as a TV;

FIG. 2 is screen shot of an example emotion entry user interface (UI);

FIG. 3 is a screen shot of the display of the viewer's display device showing the emotion rank of the video being viewed;

FIG. 4 is a screen shot of the display device, showing thumbnails of the imaged faces of other viewers pertaining to the video being presented on the display device, for the viewer to rank the faces; and

FIG. 5 is a flow chart of example logic in accordance with present principles.

### DETAILED DESCRIPTION OF THE PREFERRED EMBODIMENT

Referring initially to FIG. 1, a display device 10 includes a video display 12 and chassis 14. The display device may be, but is not limited to, a laptop computer or other computer, or a TV, etc. The display 12 may be an LCD display or other mode of display screen including a high definition (HD) TV display.

Components inside the chassis 14 can include a TV tuner 16 (when the display device is implemented by a TV), a computer readable storage medium 18 such as disk-based or solid state storage, and a processor 20. A display/circuitry driver(s) 22 can be included to receive signals from the processor 20 to drive the image on the video display 12 and an audio circuitry 24 can be included to receive signals from the processor 20 to output audio on the speakers 26.

A microphone 28, a camera 30, and an input device 32 can be included and communicate data external to the chassis 14 collected at the user's discretion to the processor 20. In some implementations, the microphone 28 and camera 30 can be built into the display chassis 14. In other embodiments, the microphone 28 and camera 30 are provided separately from the chassis 14 and communicate with the processor 20 over a wired path such as a USB path or a wireless path such as a Bluetooth path. The input device 32 may be a keyboard, keypad, mouse, voice recognition device, etc. but in the embodiment shown is a TV remote control and also communicate with the processor 20 over a wired path or a wireless path. In other implementations, multiple input devices 32 can be included.

A network interface 34 may be a wired or wireless modem and communicates with a friend's video display 36 over a wide area network (WAN) 38 such as the Internet. Alternatively, the network interface 34 may be a cable interface and can communicate with a cable head end and thence to the display devices of other users, such as the friend's video display 36. In both cases, multiple friend displays may be used in accordance with the principles below. A computer server on the Internet with one or more processors and one or more computer readable storage media may host the ranking engine discussed below.

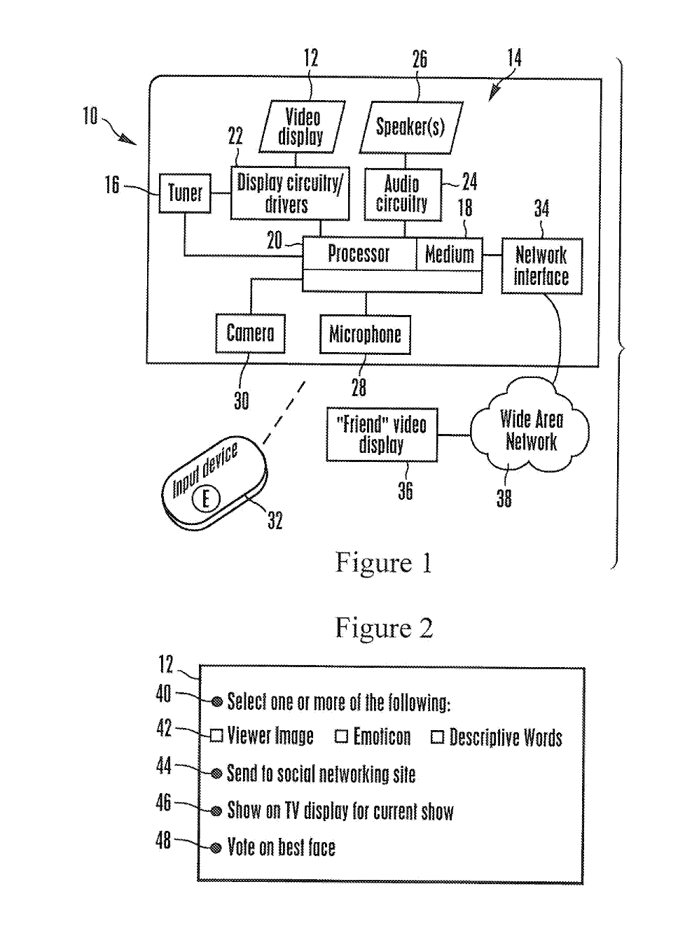

Moving in reference to FIG. 2, an example emotion presentation user interface (UI) displayed on the video display 12 allows the viewer to choose, i.e. click on, various selector elements via remote control 32. The processor 20 directs the presentation of the UI on the display 12 subsequent to the viewer's command via remote control 32 to capture an image with the camera 30 and to the actual capturing of the image by the camera 30. The processor 20 concurrently sends the captured image to the ranking engine, which is in the form of software located on the storage medium 18 and/or on an Internet server, and the image gets sent back to the processor 20 in its original format and in the form of an emotion rank. The emotion rank is either an emoticon emulating the viewer's face or descriptive words that correspond to the detected emotion.

A selector element 40 allows the user to select one or plural items from a list on the UI. The viewer selects an item by highlighting or clicking on a box adjacent to an item, i.e. the viewer image checkbox 42. The items available for selection are the original image captured by the camera 30 and the emotion rank in the form of both an emoticon and descriptive words. Once the item(s) is selected, the viewer can then choose what to do with the items by clicking on successive selector elements.

A selector element 44 allows the user to send the image of his or her face and/or the emotion rank to a social networking website on the Internet, whose address is predetermined by the viewer. Alternatively, the viewer may present the image of his or her face and/or emotional rank of the current show on the display 12 by choosing selector element 46. By choosing selector element 46, the processor 20 would resume showing of the video previously playing and overlay the image of the viewer and/or the emotion rank onto that video.

A selector element 48 allows the user to vote on the “best” face pertaining to the video currently being played. The faces that the viewer can vote on are faces downloaded from the ranking engine and presented on the display 12. The voting occurs at least in part by clicking on one of the images of viewer faces downloaded from the ranking engine and presented on the display 12. The UI further enables the viewer to vote on a face based on the face presenting a particular emotion listed on the UI.

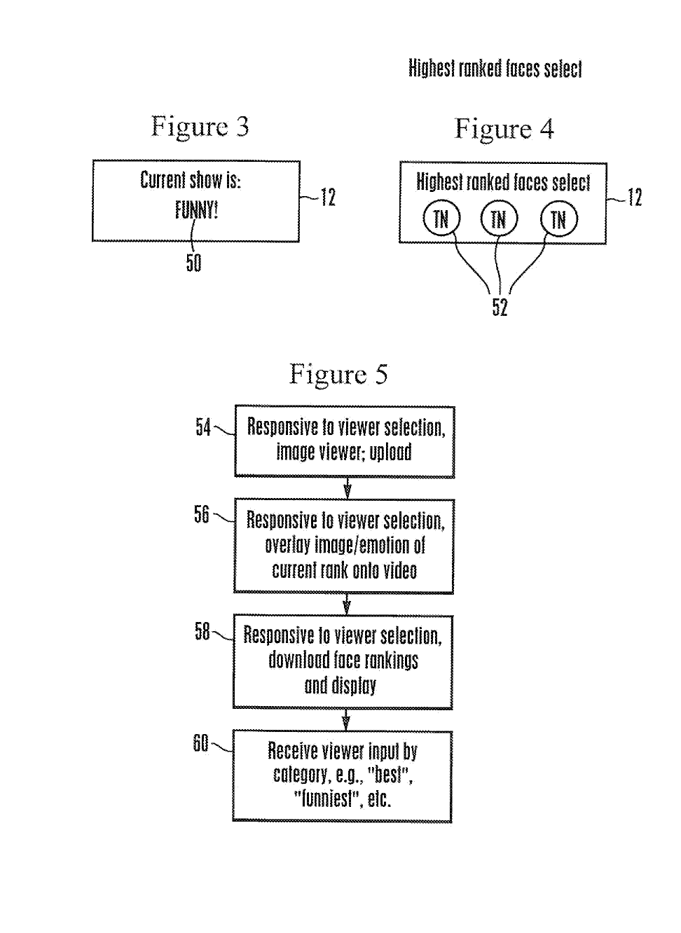

Now referring to the screen shot of FIG. 3, the emotion rank in the form of the descriptive word 50, “Funny” as shown in this embodiment, is overlaid onto the video being presented on the display 12. The viewer would have highlighted, or clicked on, the checkbox next to the descriptive word(s) item under selector element 40 listed on the UI. The viewer would have then chosen selector element 46, causing the processor 20 to overlay the chosen item, here the descriptive word “Funny,” onto the current video.

Moving in reference to the screen shot of FIG. 4, thumbnails 52 of the imaged faces of other viewers pertaining to the video being played on the display 12 are shown so that the viewer may rank, or vote on, the faces portrayed in the thumbnails 52. The viewer votes at least in part by clicking on one of the thumbnails 52 of viewer faces downloaded from the ranking engine (when it is hosted on the Internet) and presented on the display 12. The viewer is further enabled to vote on a thumbnail 52 based on the face presenting a particular emotion listed on the UI, i.e. “funniest” or “scariest,” rather than simply “the best.”

The flow chart of FIG. 5 describes example logic in accordance with present principles. Beginning at block 54, the processor 20 is responsive to the viewer's selection to capture a picture of his or her face and directs the camera 30 to capture the image. The viewer's selection to capture an image is sent to the processor 20 via input device 32, i.e. a button on remote control 32 labeled “picture.” Once the camera 30 captures the image of the viewer's face, the processor 20 uploads the image to the software ranking engine or executes a local ranking engine, which returns the image and an emotion rank.

The viewer may direct the processor 20, by using the UI displayed by the processor 20 in response to image capture, to overlay the image of his or her face or the emotion rank onto the video currently being played on the display 12 at block 56. This would enable the viewer to watch the video being played and view the image and/or emotion rank simultaneously.

Moving to block 58, the viewer may make an alternate selection on the UI to direct the processor 20 to download thumbnails 52 of other viewer's faces from the Internet. Once downloaded, the processor 20 would display the thumbnails 52 so that the viewer may vote on them. The processor 20 receives the viewer's vote via input device 32 at block 60 in terms of categories, e.g., “best,” “funniest,” etc.

Results of the vote and/or ranking may be displayed on an Internet website, on other viewer's displays, e.g., on peer displays, etc.

What is claimed is:

1. System comprising:
a viewer video display;
a processor coupled to the viewer video display;
a camera communicating with the processor;
the processor executing logic on a computer readable storage medium to generate an image of the viewer using the camera and to provide the image to a ranking mechanism, the processor receiving back from the ranking engine the original image and an emotion rank pertaining to a video presented on the display and overlaying the original image and/or emotion rank onto the video, the emotion rank being an emoticon emulating the viewer's face and/or descriptive words that correspond to the detected emotion.

2. The system of claim 1, wherein the processor presents on the display a user interface (UI) enabling a viewer to select one or more options for useable items, the items being an image of his or her face and emotion rank.

3. The system of claim 1, wherein the processor presents on the display a user interface (UI) enabling a viewer to select to have an image of his or her face and/or emotion rank uploaded to a viewer-defined social networking site on the Internet.

4. The system of claim 1, wherein the processor presents on the display a user interface (UI) enabling a viewer to select to have the image of his or her face and/or the emotion rank presented on the display.

5. The system of claim 1, wherein the processor presents on the display a user interface (UI) enabling a viewer to vote on images of viewer faces downloaded from the ranking engine and presented on the display, the images of viewer faces pertaining to the video presented on the display.

6. The system of claim 5, wherein the UI enables a viewer to vote on a “best” face at least in part by clicking on one of the images of viewer faces downloaded from the ranking engine and presented on the display; the UI further enabling a viewer to vote on a face based on the face presenting a particular emotion listed on the UI.

7. A method comprising:
generating an image of a viewer of a TV using a camera associated with the TV;
providing the image to a ranking mechanism;
receiving back from the ranking engine the image and an emotion rank pertaining to a video presented on the display; and
overlaying the original image and/or emotion rank onto the video, the emotion rank being an emoticon emulating the viewer's face and/or descriptive words that correspond to the detected emotion.

8. The method of claim 7, comprising presenting on the display a user interface (UI) enabling a viewer to select one or more options for useable items, the items being an image of his or her face and emotion rank.

9. The method of claim 7, comprising presenting on the display a user interface (UI) enabling a viewer to select to have an image of his or her face and/or emotion rank uploaded to a viewer-defined social networking site on the Internet.

10. The method of claim 7, comprising presenting on the display a user interface (UI) enabling a viewer to select to have the image of his or her face and/or the emotion rank presented on the display.

11. The method of claim 7, comprising presenting on the display a user interface (UI) enabling a viewer to vote on images of viewer faces downloaded from the ranking engine and presented on the display, the images of viewer faces pertaining to the video presented on the display.

12. The method of claim 11, wherein the UI enables a viewer to vote on a “best” face at least in part by clicking on one of the images of viewer faces downloaded from the ranking engine and presented on the display, the UI further enabling a viewer to vote on a face based on the face presenting a particular emotion listed on the UI.

13. Apparatus comprising:
a viewer video display;
a processor coupled to the viewer video display;
a camera communicating with the processor;
the processor executing logic on a computer readable storage medium to, responsive to a viewer selection to capture a picture of his or her face, causing an image of the viewer to be captured, the processor providing the image to a ranking engine, the processor receiving from the ranking engine an emotion rank, the processor responsive to user command overlaying the image and/or the emotion rank onto a video being played on the display to enable a viewer to watch the video being played and view the image and/or emotion rank simultaneously.

14. The apparatus of claim 13, wherein the processor responsive to user input presents thumbnails of other viewers on the display, the processor receiving viewer selection of a thumbnail and viewer rating thereof.

15. The apparatus of claim 13, wherein the processor presents on the display a user interface (UI) enabling a viewer to select one or more options for useable items, the items being an image of his or her face and emotion rank.

16. The apparatus of claim 13, wherein the processor presents on the display a user interface (UI) enabling a viewer to select to have an image of his or her face and/or emotion rank uploaded to a viewer-defined social networking site on the Internet.

17. The apparatus of claim 13, wherein the processor presents on the display a user interface (UI) enabling a viewer to select to have the image of his or her face and/or the emotion rank presented on the display.

18. The apparatus of claim 13, wherein the processor presents on the display a user interface (UI) enabling a viewer to vote on images of viewer faces downloaded from the ranking engine and presented on the display, the images of viewer faces pertaining to the video presented on the display.

19. The apparatus of claim 18, wherein the UI enables a viewer to vote on a “best” face at least in part by clicking on one of the images of viewer faces downloaded from the ranking engine and presented on the display, the UI further enabling a viewer to vote on a face based on the face presenting a particular emotion listed on the UI.
